(19) United States
(12) Patent Application Publication
(10) Pub. No.: US 2025/0171600 A1
(43) Pub. Date: May 29, 2025

(54) CRIMPED PROTEINACEOUS NANOFIBERS, PREPARATION AND USE THEREOF

(71) Applicant: National Taiwan University, Taipei City (TW)

(72) Inventors: Po-Ling Kuo, Taipei City (TW); Chien-Wei Wu, Changhua County (TW)

(73) Assignee: National Taiwan University, Taipei City (TW)

(21) Appl. No.: 18/519,106

(22) Filed: Nov. 27, 2023

(51) Int. Cl. C08J 3/24; B29C 35/08; D01D 5/00

(52) U.S. Cl. CPC C08J 3/24; B29C 35/0805; D01D 5/0007; B29C 2035/0827

(57) ABSTRACT

The present invention discloses a production process and use thereof of crimped proteinaceous nanofiber, wherein the production process includes the following steps: (1) passing a gelatin methacrylate (GelMA) through an electrospinning system to make an as-spun proteinaceous nanofiber; and (2) soaking the as-spun proteinaceous nanofiber in organic solvents with different concentrations to form a network of crimped proteinaceous nanofiber, and the crimped proteinaceous nanofiber can be used as biomaterials for two and three-dimensional cell culture, medical or pharmaceutical applications, etc.

### FIELD OF THE INVENTION

The present invention relates to an artificial proteinaceous fiber and its use thereof.

### BACKGROUND OF THE INVENTION

Collagen in living organisms is composed of networks constituted of nanofiber construct of different crimping degrees. Fibrous materials or systems simulating the crimped construct is usually required for research in cell culture and tissue engineering. The materials or systems need to be composed of proteinaceous materials similar to collagen in living organisms and achieve the nanometer scale in order to truly simulate the conditions in living organisms. However, the fiber diameter attained by technologies currently available for proteinaceous fiber synthesis is merely above the micron scale, which makes it difficult to approach the nanoscale. Although there exist technologies currently available to synthesize crimped fiber of diameter approaching nanometers, none of them utilizes proteinaceous materials similar to collagen.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A shows a schematic diagram of the synthesis of a crimped proteinaceous nanofiber and the photo-crosslinking of the fibers reacted with LAP. FIG. 1B shows a schematic diagram of the electrospinning setup and scanning electron microscope images of the random and aligned as-spun proteinaceous nanofibers formed by controlling the rotating mandrel collector. FIG. 1C illustrates a schematic diagram of the process for synthesis of the crimped proteinaceous nanofibers. Abbreviation: GelMA stands for gelatin methacrylate; LAP is lithium phenyl-2,4,6-trimethyl-benzoyl phosphinate.

FIGS. 2A-2D display the scanning electron microscopy images of proteinaceous nanofibers with different crimping degrees produced by soaking fibers in different concentrations of ethanol. FIG. 2A shows proteinaceous nanofibers without soaking in ethanol. FIG. 2B shows the proteinaceous nanofibers soaked in 90% ethanol. FIG. 2C shows the proteinaceous nanofibers soaked in 95% ethanol. FIG. 2D shows the proteinaceous nanofibers soaked in 97.5% ethanol. FIGS. 2E and 2F show the analysis of crimping degree and diameter of fibers shown in FIGS. 2A-D, respectively.

FIG. 3 shows scanning electron microscope images of proteinaceous nanofiber constructs prepared under different ambient temperatures.

FIG. 4 shows a macroscopic photo of proteinaceous nanofiber sheets after a critical point drying (CPD) process.

FIG. 5 shows a stress-strain curve obtained by material property measurements of proteinaceous nanofibers with different crimping degrees. FIG. 5A shows a photo of a proteinaceous nanofiber placed on a tensile test instrument through clamping, and the stress and strain of the materials were measured through stretching. FIG. 5B shows a stress-strain curve diagram of crimped proteinaceous nanofiber and straight proteinaceous nanofiber. FIG. 5C shows the stress-strain curves of the as-spun proteinaceous nanofiber, the straight proteinaceous nanofiber, and the crimped proteinaceous nanofiber. FIG. 5D shows the stress-strain curves of random and aligned crimped proteinaceous nanofiber. FIG. 5E shows an analysis diagram of Young's modulus of proteinaceous nanofibers with different crimping degrees. FIG. 5F shows an analysis diagram of the yield strain of proteinaceous nanofibers with different crimping degrees. FIG. 5G shows an analysis diagram of the yield stress of proteinaceous nanofibers with different crimping degrees. FIG. 5H shows a strain analysis diagram of the toe regions of proteinaceous nanofibers with different crimping degrees.

FIG. 6A shows the live/dead cell staining assays for NIH 3T3 fibroblasts and bone marrow-derived mesenchymal stem cells (BMSCs) cultured on crimped proteinaceous nanofibers for 48 hours. Live cells stained by Calcein AM exhibited green fluorescence, and dead cells stained by Propidium Iodide exhibited red fluorescence. FIG. 6B shows the cell cytotoxicity testing graph of crimped proteinaceous nanofibers determined using the CCK8 kit. FIG. 6C shows the quantitative analysis result of the cell viability shown in FIG. 6A.

FIG. 7A shows scanning electron microscope images of NIH 3T3 fibroblasts grown on proteinaceous nanofibers with different crimping degrees.

FIG. 7B shows scanning electron microscope images of BMSCs grown on proteinaceous nanofibers with different crimping degrees.

### DETAILED DESCRIPTION OF THE INVENTION

Other features and advantages of the present invention will be disclosed from the following non-limiting detailed description and examples.

As used herein “a”, “the”, “at least one”, and “one or more” are used interchangeably.

In order to understand the present invention more easily, certain terms are first defined and additional definitions are set forth throughout the detailed description.

The term “fiber” includes interconnected or stacked networks.

The present invention provides a method for manufacturing a crimped proteinaceous nanofiber, which includes the following steps: (1) using a gelatin methacrylate (GelMA) to make an as-spun proteinaceous nanofiber through an electrospinning system; and (2) soaking the as-spun proteinaceous nanofiber in an organic solution to form the crimped proteinaceous nanofiber.

In one embodiment, the electrospinning system in step (1) further comprises the following steps between the step (1) and the step (2): (1a) dissolving the GelMA in hexafluoroisopropanol (1,1,1,3,3,3-Hexafluoro-2-propanol, HFIP) to form a GelMA solution of a specified weight volume percentage concentration; (1b) filtering the bacteria out of the GelMA solution through a polytetrafluoroethylene (PTFE) syringe filter and place the filtered GelMA solution into a syringe; (1c) setting up the syringe on a syringe pump and connecting the syringe pump to a blunt needle tip, pumping out the GelMA solution at a suitable pumping rate (such as 1 ml per hour) to form the as-spun proteinaceous nanofiber; and (1d) setting a high voltage electric field between the blunt needle tip and a rotating mandrel collector, and collecting the as-spun proteinaceous nanofiber with the rotating mandrel collector.

In another embodiment, the high voltage electric field is 5-30 kV. In a preferred embodiment, the high voltage electric field is 10-20 kV. In a more preferred embodiment, the high voltage electric field is 15 kV.

In another embodiment, the specified weight volume percentage concentration of the GelMA is 1-20%. In a preferred embodiment, the specified weight volume percentage concentration of the GelMA is 4-14%. In a more preferred embodiment, the specified weight volume percentage concentration of the GelMA is 4.5-13.5%.

In another embodiment, which further comprises a step (3) exposing the crimped proteinaceous nanofiber and a photoinitiator with a specific wavelength of light to conduct a photo-crosslinking reaction to form a photo-crosslinked crimped proteinaceous nanofiber.

In another embodiment, the step (3) further comprises the ambient temperature being 4-40° C. when conducting the photo-crosslinking reaction. In a preferred embodiment, the ambient temperature is 18-25° C. In a more preferred embodiment, the ambient temperature is 18° C. or 25° C.

In another embodiment, which further comprises a step (4) soaking the photo-crosslinked crimped proteinaceous nanofiber in absolute ethanol and going through a critical point dry (CPD) process to form a dry crimped proteinaceous nanofiber which can be stored at room temperature for a long time and maintain its shape.

In the present invention, the operating steps of the CPD are: (1) putting the container soaking the photo-crosslinked crimped proteinaceous nanofibers in absolute ethanol into the CPD device; (2) adding liquid carbon dioxide by the CPD device to mix with the absolute ethanol in the absolute ethanol container so that the liquid carbon dioxide completely replaces the absolute ethanol; and (3) increasing the temperature and pressure in the CPD device. When the temperature and pressure reach the critical point of carbon dioxide (35° C. and 1,200 psi), liquid carbon dioxide will be in a state of coexistence of vapor and liquid, and drying can be achieved by slowly releasing the carbon dioxide.

In one embodiment, the organic solution is alcohols or ketones. In a preferred embodiment, the organic solution is alcohol. In a more preferred embodiment, the organic solution is ethanol.

In another embodiment, the ethanol concentration is 70-98.5%. In a preferred embodiment, the ethanol concentration is 80-98%. In a more preferred embodiment, the ethanol concentration is 90-97.5%.

In another embodiment, the photoinitiator is yellow eosin (Eosin-Y), 2-hydroxy-1-[4-(2-hydroxyethoxy)phenyl]-2-methyl-1-Acetone (Irgacure 2959) or Lithium phenyl-2,4,6-trimethyl-benzoyl phosphinate (LAP).

In another embodiment, the wavelength of the specific wavelengths of light is 200-520 nm. In a preferred embodiment, the wavelength of the specific wavelengths of light is 250-370 nm. In a preferred embodiment, the wavelength of the specific wavelengths of light is 365 nm.

In another embodiment, the method of manufacturing the GelMA includes the following steps: (1) mixing a gelatin and a methacrylic anhydride in a carbonate-bicarbonate buffer to form a mixed solution; (2) adjusting the mixed solution to a suitable pH value and then dialyzing and purifying the mixed solution with double distilled water to form a GelMA mixed solution; and (3) the GelMA mixed solution is subjected to a freeze-drying process to form a white solid of GelMA.

In another embodiment, the ratio of the gelatin and the methacrylic anhydride is 5-100 g:1 mL. In a preferred embodiment, the ratio of the gelatin and the methacrylic anhydride is 7.5-50 g:1 mL. In a more preferred embodiment, the ratio of the gelatin and the methacrylic anhydride is 10 g:1 mL.

In another embodiment, the suitable pH value is 7-8. In a preferred embodiment, the suitable pH value is 7.4.

In another embodiment, the conditions of the freeze-drying process include: the temperature is −80 to −30° C., and the pressure is evacuated to below 611 Pa.

The present invention also provides the crimped proteinaceous nanofiber with a crimping degree of 0.40-0.98.

In a preferred embodiment, the crimping degree of the crimped proteinaceous nanofiber is 0.50-0.97. In a more preferred embodiment, the crimping degree of the crimped proteinaceous nanofiber is 0.7-0.96.

In another embodiment, the diameter of the crimped proteinaceous nanofiber is 200-1000 nm. In a preferred embodiment, the diameter of the crimped proteinaceous nanofiber is 400-800 nm.

In another embodiment, the crimped proteinaceous nanofiber can be used for cell culture, drug screening, wound repair, prostheses or phantoms, drug carriers, tissue organ chips, or tissue engineering.

### EXAMPLE

The following examples are non-limiting and only represent various aspects and features of the present invention.

### Embodiment 1: Manufacturing Method of the Crimped Proteinaceous Nanofiber

The manufacturing method of the crimped proteinaceous nanofiber of the present invention is shown in FIG. 1, and the steps include:

(1) Making a gelatin methacrylate (GelMA) freeze-dried sheets: mixing a gelatin and a methacrylic anhydride in a 0.1M carbonate-bicarbonate buffer in a ratio of 10 g:1 mL to form a mixed solution and adjusting the pH value of the mixed solution to 7.4. Dialyzing and purifying the mixed solution with double distilled water to form a GelMA mixed solution. And the GelMA mixed solution is subjected to a freeze-drying process (the temperature is −80 to −30° C., and the pressure is evacuated to less than 611 Pa) for purification to form a white solid of GelMA. This form of the GelMA is easy to preserve, and it will be used as the material of the proteinaceous nanofiber.

(2) Synthesizing an as-spun proteinaceous nanofiber: dissolving the GelMA in hexafluoroisopropanol (1,1,1,3,3,3-Hexafluoro-2-propanol, HFIP) to form a GelMA solution. After filtering the bacteria out of the GelMA solution through a 0.45 μm polytetrafluoroethylene (PTFE) syringe filter, place the GelMA solution into a 5 ml syringe. The syringe is set onto a syringe pump and connected to a 19G blunt needle tip, and the GelMA solution is pumped out at a pumping rate of 1 ml per hour to form an as-spun proteinaceous nanofiber with a diameter between 200-1000 nm. The distance between the needle tip and a rotating mandrel collector is 15 cm. The rotating mandrel collector is covered with aluminum foil. A high-voltage electric field between the needle tip and the rotating mandrel collector is set to 15 kV. The rotating mandrel collector will rotate for 3 hours to collect the as-spun proteinaceous nanofiber on the aluminum foil.

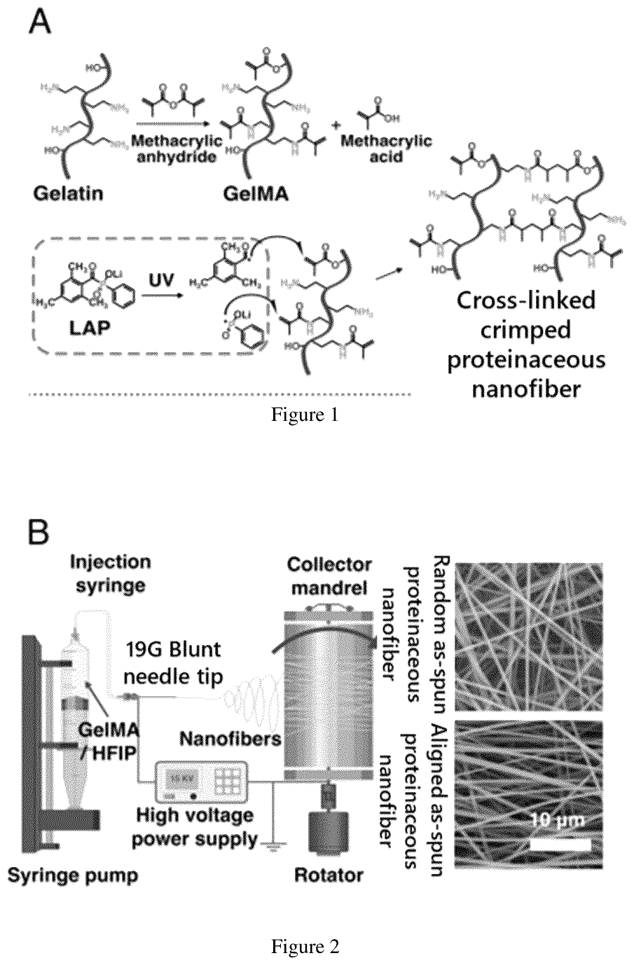

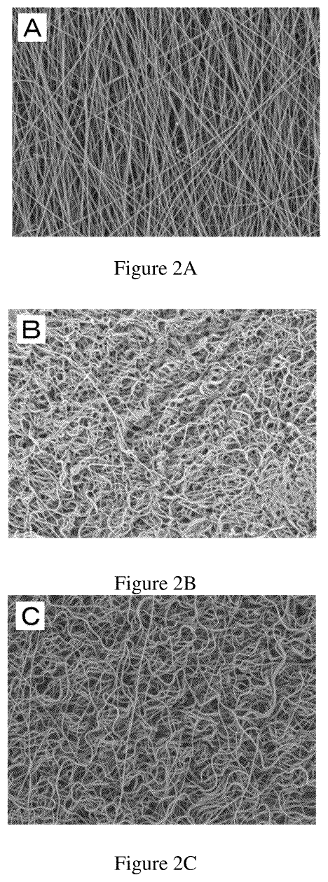

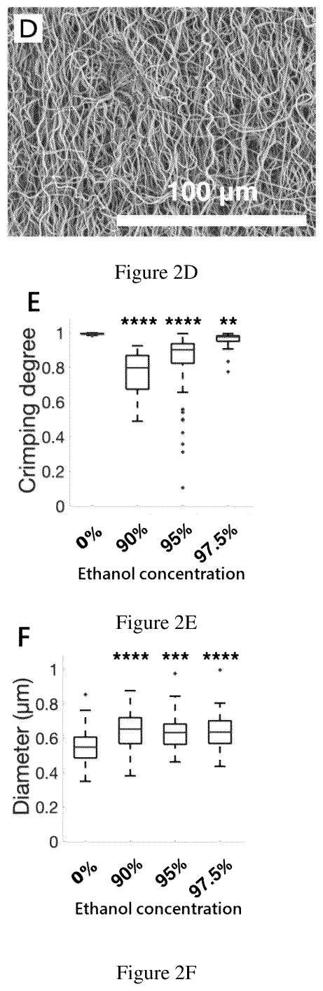

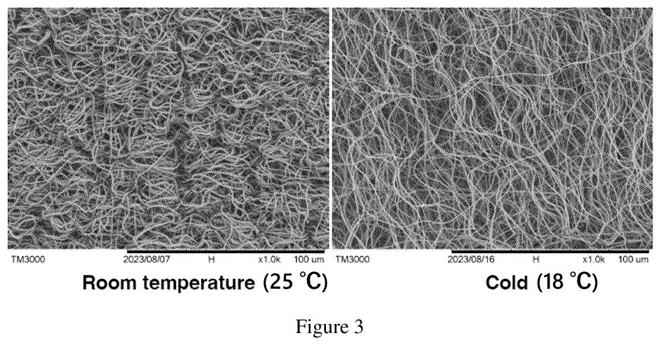

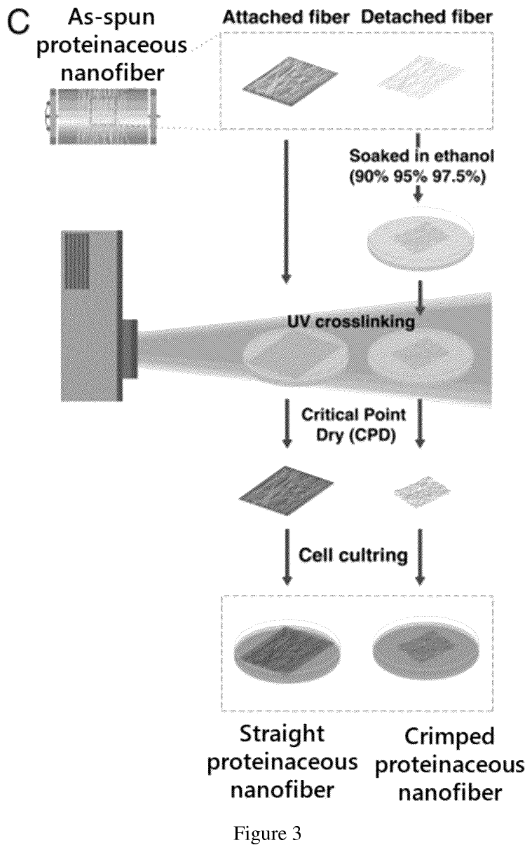

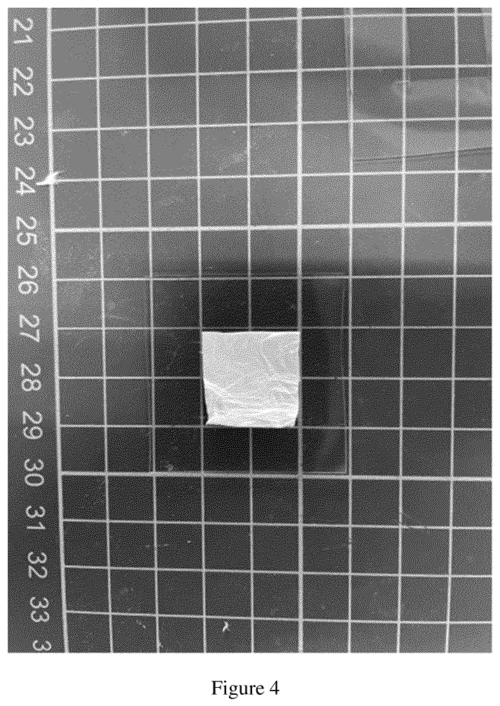

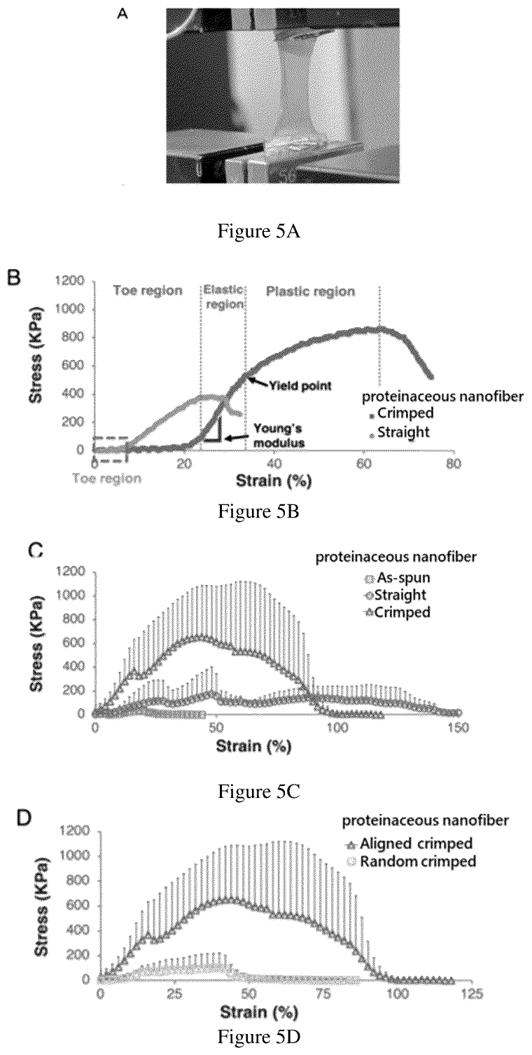

(3) Making a crimped proteinaceous nanofiber: removing the as-spun proteinaceous nanofiber from the rotating mandrel collector and soaking them in ethanol solution (organic solutions) of different concentrations to form a crimped proteinaceous nanofiber. The water content in the ethanol solution will determine the crimping degree of the crimped proteinaceous nanofiber, as shown in Table 1. As shown in FIG. 2, the crimped proteinaceous nanofibers soaked in ethanol of different concentrations will have different crimping degrees and fiber diameters. Then a 0.25% lithium phenyl-2,4,6-trimethyl-benzoyl phosphinate (LAP) is dissolved in the ethanol solution which soaks crimped proteinaceous nanofibers. In order to maintain the crimping degree of the crimped proteinaceous nanofiber, the crimped proteinaceous nanofiber is exposed to 365 nm UV light (absorption light of LAP) for 25 minutes to go through a photo-crosslinking reaction to form a photo-crosslinked crimped proteinaceous nanofiber. At the same time, during the photo-crosslinking reaction, the ambient temperature is controlled to a low temperature of 18° C. or a high temperature of 25° C. to produce different density levels of the photo-crosslinked crimped proteinaceous nanofiber, as shown in FIG. 3.

In this embodiment, the organic solution may be alcohols or ketones. In this embodiment, the photoinitiator can be yellow eosin (Eosin-Y), 2-hydroxy-1-[4-(2-hydroxyethoxy)phenyl]-2-methyl-1-Acetone ((Irgacure 2959) or lithium phenyl-2,4,6-trimethyl-benzoyl phosphinate (LAP).

The formula of the crimping degree: Lₛ/L_{f} (Lₛ: straight distance between two ends; L_{f}: fiber contour length. When the crimping degree of the proteinaceous nanofiber=1, it is a straight proteinaceous nanofiber. When the crimping degree of the proteinaceous nanofiber <0.97, it is a crimped proteinaceous nanofiber.)

TABLE 1
Average crimping degree of crimped proteinaceous nanofibers
soaked in ethanol solution of different concentrations.

| Ethanol concentration | Average crimping degree | standard deviation |
|---|---|---|
| unsoaked | 0.9931302 | 0.0041 |
| 90% | 0.761857425 | 0.1366 |
| 95% | 0.857412702 | 0.1403 |
| 97.5% | 0.95806416 | 0.0477 |

The straight proteinaceous nanofibers are formed by an attached fiber attached to the aluminum foil on the rotating mandrel collector. The crimped proteinaceous nanofibers are formed by soaking a separated fiber detached from the aluminum foil on the rotating mandrel collector in ethanol (FIG. 1C).

(4) Preserving the crimped proteinaceous nanofiber: Switch the photo-crosslinked crimped proteinaceous nanofibers in the absolute ethanol for soaking, and preserve the material by a critical point drying (CPD) process.

The operating steps of the CPD are: (1) putting the absolute ethanol container soaking the photo-crosslinked crimped proteinaceous nanofibers into the CPD device; (2) adding liquid carbon dioxide by the CPD device to mix with the absolute ethanol in the absolute ethanol container so that the liquid carbon dioxide completely replaces the absolute ethanol; and (3) increasing the temperature and pressure in the CPD device. When the temperature and pressure reach the critical point of carbon dioxide (35° C. and 1,200 psi), liquid carbon dioxide will be in a state of coexistence of vapor and liquid, and drying can be achieved by slowly releasing the carbon dioxide.

The photo-crosslinked crimped proteinaceous nanofibers after CPD can be stored at room temperature for a long time and maintain their crimped shape.

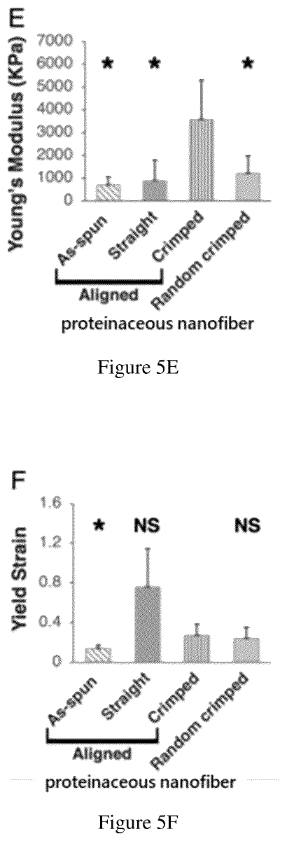

FIG. 4 shows a macroscopic photo of proteinaceous nanofiber sheets after CPD.

### Embodiment 2: Mechanical Property Measurement

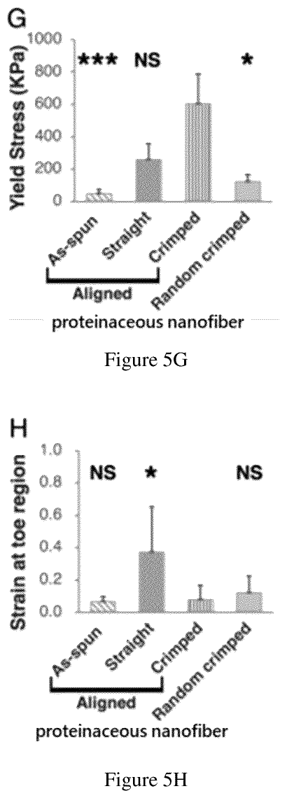

The crimped proteinaceous nanofibers are fixed to the tensile test instrument, and the stress-strain curve of the crimped proteinaceous nanofibers is depicted, as shown in FIG. 5. From the results, the stress-strain curve of the crimped proteinaceous nanofibers shows that there is a non-linear region called the toe region at the beginning of the stress-strain curves of the crimped proteinaceous nanofibers, implying that the crimped proteinaceous nanofibers have good stretchability.

### Embodiment 3: Cell Staining Assay

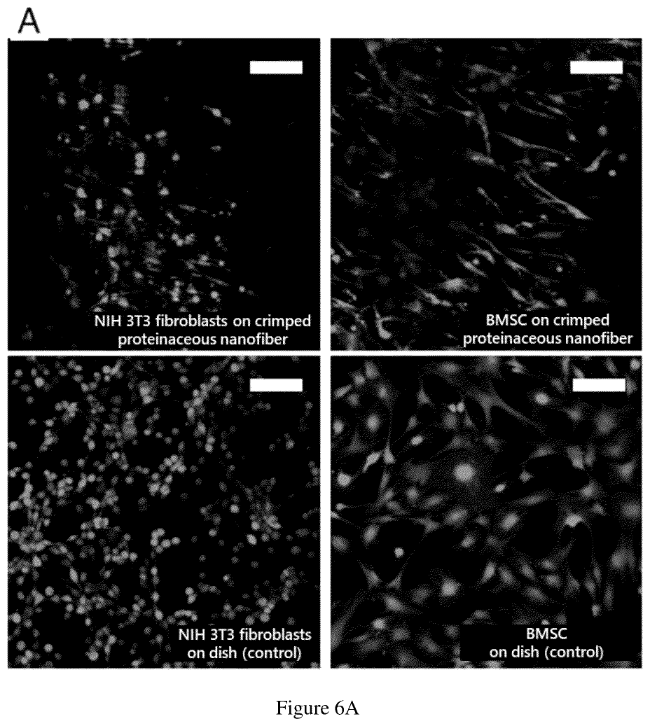

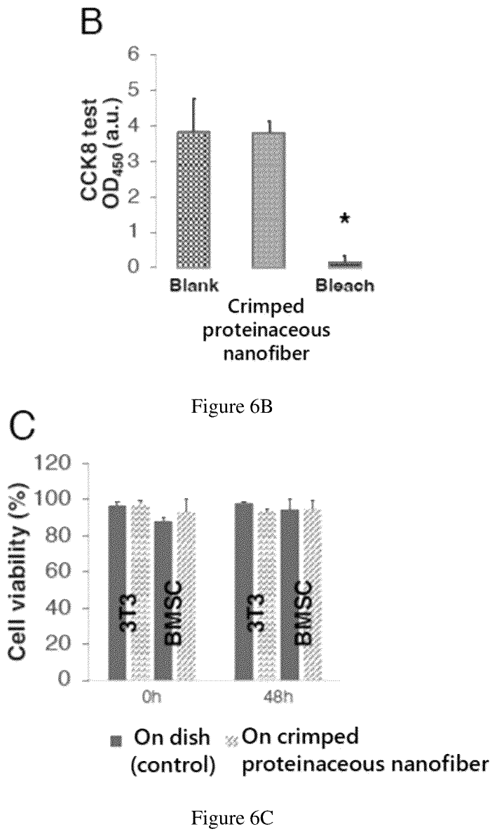

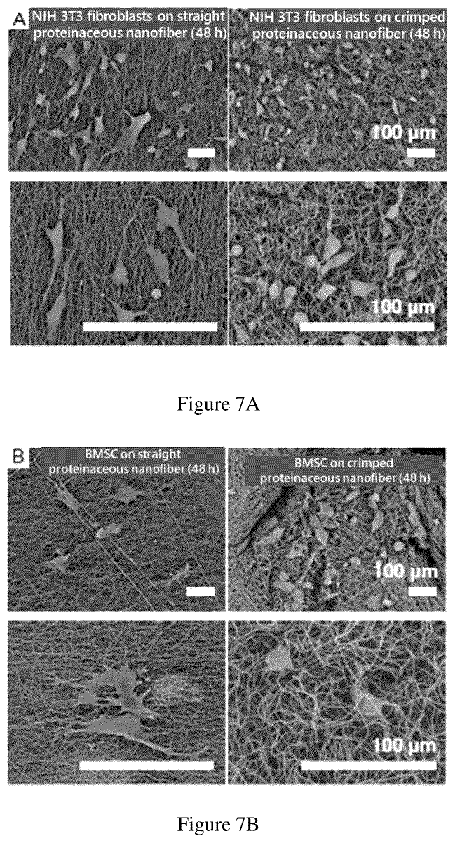

Cell staining live/dead assays were done after culturing NIH 3T3 fibroblasts and bone marrow-derived mesenchymal stem cells (BMSC) on the crimped proteinaceous nanofibers for 48 hours. Live cells stained by Calcein AM shows green fluorescence, and dead cells stained by Propidium Iodide shows red fluorescence. The results are shown in FIG. 6A.

### Embodiment 4: Cytotoxicity Test

The CCK8 kit was used to test the cytotoxicity of the crimped proteinaceous nanofibers. The cells used were NIH 3T3 fibroblasts cultured in a 96-well plate, and the cell number was approximately 10⁴ cells per well. After cell culture, cell viability was determined using CCK8 reagent. The absorbance detection wavelength of the reagent is 450 nm. The experimental groups are (1) a blank group using only NIH 3T3 fibroblasts and culture medium; (2) an experimental group using culture medium soaked with the crimped proteinaceous nanofibers; and (3) a control group using bleach as the presence of cytotoxicity. According to the results in FIG. 6B, the cell viability of the experimental group and the blank group are similar, confirming that the crimped proteinaceous nanofibers have no obvious toxicity to cells.

### Embodiment 5: Cell Viability Test

NIH 3T3 fibroblasts and bone marrow-derived mesenchymal stem cells (BMSC) were cultured on the crimped proteinaceous nanofibers. After 48 hours of culturing, Calcein AM and Propidium Iodide reagents were used to quantify the cell viability. The results in FIG. 6C show that the cell viability is still over 90% after 48 hours, proving that the culture environment made of crimped proteinaceous nanofibers is not cytotoxic.

Although the present invention has been described and illustrated in sufficient detail to enable those skilled in the art to make and use it, various substitutions, modifications and improvements will be apparent without departing from the spirit and scope of the present invention.

Those skilled in the art will readily appreciate that the present invention is well adapted to achieve the above objects and obtain the above objects and advantages, as well as those inherent therein. The processes and methods for their production described above represent preferred embodiments, are illustrative and do not limit the scope of the invention. Modifications and other uses will occur to those skilled in the art. These modifications are included within the spirit of the invention and are defined by the scope of the claims.

What is claimed is:

1. A method for manufacturing a crimped proteinaceous nanofiber, which includes the following steps:
(1) using a gelatin methacrylate (GelMA) to make an as-spun proteinaceous nanofiber through an electrospinning system; and
(2) soaking the as-spun proteinaceous nanofiber in an organic solution to form the crimped proteinaceous nanofiber.

2. The method of claim 1, which further comprises a step (3) exposing the crimped proteinaceous nanofiber and a photoinitiator with a specific wavelength of light to conduct the photo-crosslinking reaction to form a photo-crosslinked crimped proteinaceous nanofiber.

3. The method of claim 2, wherein the step (3) further comprises that the ambient temperature is 4-40° C. when conducting the photo-crosslinking reaction.

4. The method of claim 2, which further comprises a step (4) soaking the photo-crosslinked crimped proteinaceous nanofiber in absolute ethanol and going through a critical point dry (CPD) process to form a dry crimped proteinaceous nanofiber.

5. The method of claim 1, wherein the organic solution is alcohols or ketones.

6. The method of claim 2, wherein the photoinitiator is yellow eosin (Eosin-Y), 2-hydroxy-1-[4-(2-hydroxyethoxy)phenyl]-2-methyl-1-Acetone (Irgacure 2959) or Lithium phenyl-2,4,6-trimethyl-benzoyl phosphinate (LAP).

7. The method of claim 2, wherein the wavelength of the specific wavelengths of light is 200-520 nm.

8. The method of claim 1, wherein the method of manufacturing the GelMA includes the following steps:
(1) mixing a gelatin and a methacrylic anhydride in a carbonate-bicarbonate buffer to form a mixed solution;
(2) adjusting the mixed solution to a suitable pH value and then dialyzing and purifying the mixed solution with double distilled water to form a GelMA mixed solution; and
(3) the GelMA mixed solution is subjected to a freeze-drying process to form a white solid GelMA.

9. The crimping degree of the crimped proteinaceous nanofiber is 0.40-0.98.

10. The crimped proteinaceous nanofiber of claim 9, wherein the crimped proteinaceous nanofiber can be used for cell culture, drug screening, wound repair, prostheses or phantoms, drug carriers, tissue organ chips, or tissue engineering.
